(19) United States
(12) Patent Application Publication
(10) Pub. No.: US 2003/0069950 A1
(43) Pub. Date: Apr. 10, 2003

(54) Configuration server updating

(75) Inventor: Eric J. Gieseke, Lincoln, MA (US)

Correspondence Address: Fogg Slifer Polglaze Leffert & Jay, P.A., P.O. Box 581009, Minneapolis, MN, 55458-1009, US

(73) Assignee: ADC Broadband Access Systems Inc.

(21) Appl. No.: 10/179,539

(22) Filed: Jun. 25, 2002

Related U.S. Application Data
(60) Provisional application No. 60/327,058, filed on Oct. 4, 2001.

(51) Int. Cl. G06F 15/177

(52) U.S. Cl. 709/221

(57) ABSTRACT

An improved configuration server apparatus and method is detailed that manages configuration and tasking of devices, elements, or links of networks or networks rack systems. The improved configuration server apparatus and method allows for dynamic updates of configuration components, that are utilized by the configuration server to generate configuration responses, by identifying stale configuration components and managing their dynamic updating in response to configuration change events that affect the underlying input files and information databases.

### RELATED APPLICATION

This application claims priority to U.S. Provisional Patent Application Serial No. 60/327,058 filed Oct. 4, 2001 and titled “Configuration Server Updating,” which is commonly assigned and incorporated by reference herein.

### FIELD

The present invention relates generally to configuration updating and in particular the present invention relates to provisioning servers and configuration servers in networks.

### BACKGROUND

Modern networks and network rack systems are typically constructed of multiple differing devices, elements, or links, referred to collectively herein as elements. These elements can each have multiple configurations, settings, and polices depending on the specific task the element has within the network or system. Additionally, these elements are often of a general application type such that they require configuration to perform their purpose in the network or network system. Examples of such networks and network systems include cable modem networks and network modular rack systems.

Configuring and tasking elements in networks and network rack systems is typically the job of a configuration server. Examples of configuration servers include, but are not limited to, network provisioning servers, and system configuration servers for modular rack systems.

Configuration servers are typically internally comprised of configuration components that are utilized to generate the required configuration, typically with little or no processing effort by the configuration server, for a particular network element or system element that requests it. The configuration components in turn are typically generated at initialization of the configuration server from underlying configuration input files or information databases for all known hardware that is connected to the system or network that the configuration server controls. Once the configuration components are initialized the configuration server can generate and send out the appropriate configurations to all requesting elements, devices, and services in the system or network under management.

Networks and network systems are typically rarely ever static in their configuration and setup. Changes or additions are typically quite frequently made to the network or system by users, administrators, or other programs and/or devices. These changes or additions are seen at the configuration server as “configuration change events” and have the effect of changing or adding to the configuration components maintained by the configuration servers. A typical configuration change event is affected or initiated by a simple network management protocol (SNMP) request to the configuration server. However, other configuration change events or inputs; are possible.

Configuration change events typically require the regeneration of the configuration components of the configuration server. Until a regeneration is done the configuration server may not know which configuration components, and therefore generated configurations that it sends to requesting devices or services, are up to date. The regeneration operation is resource intensive on the configuration server and can delay responses to configuration requests, as configuration component regeneration requires that the configuration server stop servicing configuration requests until all components are checked and updated. In the meanwhile, all devices that request a configuration are unable to complete their setup and therefore are unavailable to the network, system, or end-user until regeneration is complete, a process that can take several minutes on complex systems. As configuration change requests are a frequent occurrence the probability of this delay is high.

For the reasons stated above, and for other reasons stated below which will become apparent to those skilled in the art upon reading and understanding the present specification, there is a need in the art for a method of conveniently managing and updating configurations in a configuration server in a network environment.

### SUMMARY

The above-mentioned problems with conveniently managing, and updating configurations in a configuration server are addressed by embodiments of the present invention and will be understood by reading and studying the following specification.

In one embodiment, a method of operating a configuration server with a number of configuration components includes receiving a configuration change event, identifying each configuration component as stale, and updating each configuration component as the configuration component is referenced by a request to the configuration server.

In another embodiment, a method of dynamically updating a number of configuration components includes receiving a configuration change event, marking each of the configuration components as stale, and updating each configuration component as the configuration component is accessed.

In still another embodiment, a method of operating an object oriented configuration server with a plurality of configuration objects includes receiving a configuration change event, marking all configuration objects as stale, and updating each configuration object as the configuration object is referenced by a request to the configuration server.

In yet another embodiment, a method of operating an object oriented configuration server with a plurality of configuration objects includes receiving a configuration change event, determining which configuration objects are affected by the configuration change event identifying each configuration object that is affected by the configuration change event as stale, and updating each stale configuration object as the configuration object is referenced by a request to the configuration server.

In another embodiment, a configuration server includes a memory, a network interface, a processor coupled to the memory and the network interface, and a computerusable medium having computer readable instructions stored thereon for execution by a processor to perform a method. The method includes, initializing a number of configuration components in the memory, receiving a configuration change event, marking all configuration components as stale, and selectively updating each stale configuration component when the configuration server load is below a specified threshold.

In yet another embodiment, a computer-usable medium has computer readable instructions stored thereon for execution by a processor to perform a method. The method includes, initializing a number of configuration components, receiving a configuration change event, marking each configuration component as stale, and updating each configuration component as the configuration component is referenced by a request to the configuration server.

In another embodiment, a method of dynamically updating a number of configuration components includes receiving a configuration change event, identifying selected configuration components as stale, and updating stale configuration components according to a selected update algorithm.

Other embodiments are described and claimed.

### BRIEF DESCRIPTION OF THE DRAWINGS

FIG. 1 is a simplified flowchart of a main algorithm of an embodiment of the present invention.

FIGS. 2A and 2B are simplified flowcharts of component identifying methods of embodiments of the present invention.

FIGS. 3A and 3B are simplified flowcharts of component updating methods of embodiments of the present invention.

FIGS. 4A, 4B, and 4C are simplified flowcharts of component updating methods of embodiments of the present invention where the configuration server resource usage has dropped below a specified threshold value.

### DETAILED DESCRIPTION

In the following detailed description, reference is made to the accompanying drawings that form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

Embodiments of the present invention include network configuration servers that dynamically update their internal configuration components upon receiving a configuration change event without excessive loading of the configuration server or degradation of its performance.

Provisioning servers are commonly used in network environments to configure attached network elements and to set policies and service levels. An example of a common network implementation that contains a provisioning server is that of a cable modem (CM) network wherein multiple cable modem types, network links, policies, and service level agreements (SLAs) exist. Such provisioning servers are responsible for implementing and maintaining the desired network configuration. In so doing, they provide to each network element upon request the appropriate configuration, policy setting, and/or SLA setting desired for that element in the network. Network elements in this definition include, but are not limited to, network links, routers, cable modems (CMs), cable modem termination systems (CMTS), media termination adapters (MTAs), and SNMP compliant devices or agents.

Configuration servers are another commonly used element of network environments that are highly similar in function to provisioning servers. However, where the provisioning server is concentrated on network configuration, the configuration server is specific to a system or one or more rack frames of elements that comprise a system. Configuration servers are responsible for implementing and maintaining a desired system configuration for the application or applications that the system is specifically used for. Examples of such possible applications are a dynamic host configuration protocol (DHCP) server, a CMTS system, etc. In so doing, they provide to each network element upon request the appropriate configuration, policy setting, and/or SLA setting desired for that element. The configuration, policy setting, and/or SLA setting is referred to herein as a “configuration”.

Both configuration servers and provisioning servers are, for the purposes of this disclosure, referred to jointly as “configuration servers,”.

Configuration change events, which are events that require a change in one or more configuration components or files maintained by the configuration server, occur on a frequent basis and affect a change to the system or network being managed. The maintained configuration components or files, referred to herein as “configuration components”, are generated from configuration input files or information databases and reflect the desired state of the managed network or system. The configuration components are utilized to generate the configuration file that is sent back to each element of the system or network as that element requests it. A common configuration database is an SNMP management information base (MIB). A typical configuration change event is affected or initiated by an SNMP request to the configuration server. However, other configuration change events or inputs are possible.

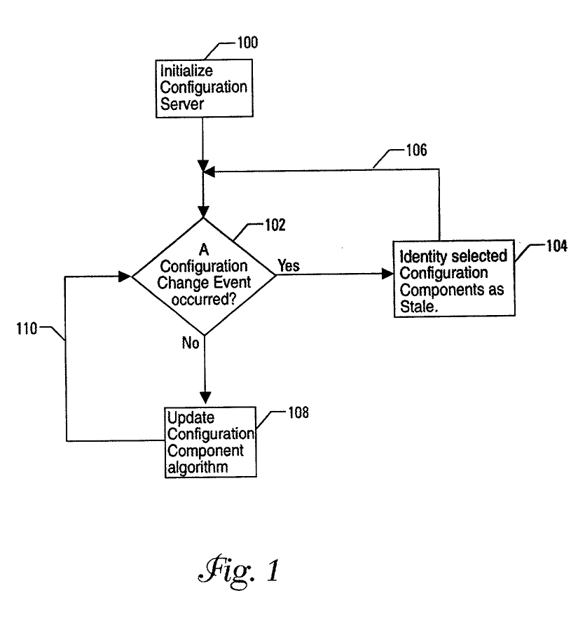

FIG. 1 is a flowchart diagram of an embodiment of the present invention that details one configuration change event algorithm of a dynamically updating configuration server. In the flowchart of FIG. 1, the configuration server is first initialized in block 100 and configuration components are generated from underlying configuration input files or information databases for all known hardware that is connected to the system or network that the configuration server controls. Once initialized, the configuration server generates and sends out the appropriate configurations to all requesting (not shown) devices and services in the system or network under management. In decision block 102, it is determined whether a configuration change event has occurred. When a configuration change event occurs, the configuration server identifies, or “marks”, selected configuration components maintained by the configuration server as being “stale” or out of date in block 104. Once the stale configuration components are identified, the configuration server loops and returns to check for any additional change events 102. If no configuration event has occurred as determined by decision block 102, the configuration server updates one or more of the stale configuration components at a time in block 108, in one embodiment according to a selected update algorithm, and then loops to check for additional configuration change events in block 102. If no additional configuration change events 102 have occurred, the configuration server continues to update stale configuration components in block 108 according to its update algorithm.

It is noted that the actual timestamp or marker that identifies a configuration component as stale ranges from a simple bit flag to a chronological or sequential timestamp and therefore has multiple implementations in various embodiments of the present invention. The different variations affect the manner in which the configuration is checked for staleness and updated in the embodiments of the present invention. In the case of the simple bit flag, the bit flag is checked when updating occurs. If the bit flag is set, the configuration component is identified as stale and is updated from the underlying configuration input files or information databases. With a timestamping approach the chronological or sequential timestamp associated with the configuration component is checked against the timestamp of an underlying configuration input file or information database or a last configuration change event timestamp and is considered stale if it is found to be older. The configuration component is then updated from the underlying configuration input files or information databases and the timestamp updated.

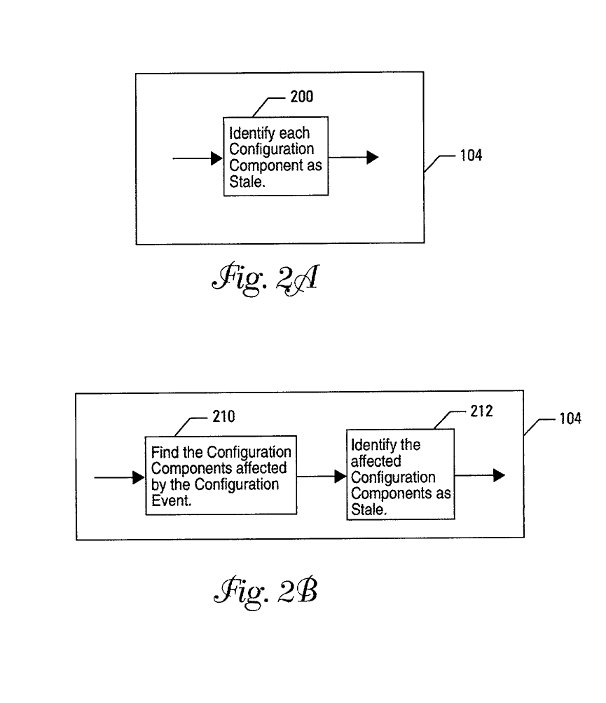

FIGS. 2A and 2B are flowchart diagrams of other methods of the present invention that identify the stale configuration components of the configuration server. The methods of FIGS. 2A and 2B relate to block 104 in FIG. 1.

FIG. 2A is a flowchart of a method of identifying stale configuration components, according to one embodiment, in which each configuration component managed by the configuration server is identified in block 200 as being potentially stale whenever a configuration change event occurs. An advantage of this approach is its simplicity and low overhead on the configuration server, aside from the resources necessary to identify each configuration component as stale.

FIG. 2B is a flowchart diagram of a more detailed approach to identifying the stale configuration components that are maintained by a configuration server in response to a configuration change event. In FIG. 2B, after a configuration change event is received, the configuration server locates those configuration components that were affected by the configuration change event in block 210. The configuration server then identifies only those affected configuration components as stale in block 212. In one embodiment, a table is maintained in memory or in a file that maps the underlying configuration input files or information databases to their generated configuration component(s). In another embodiment, a series of linked lists or pointers are maintained that link the underlying configuration input files or information databases to their generated configuration component(s).

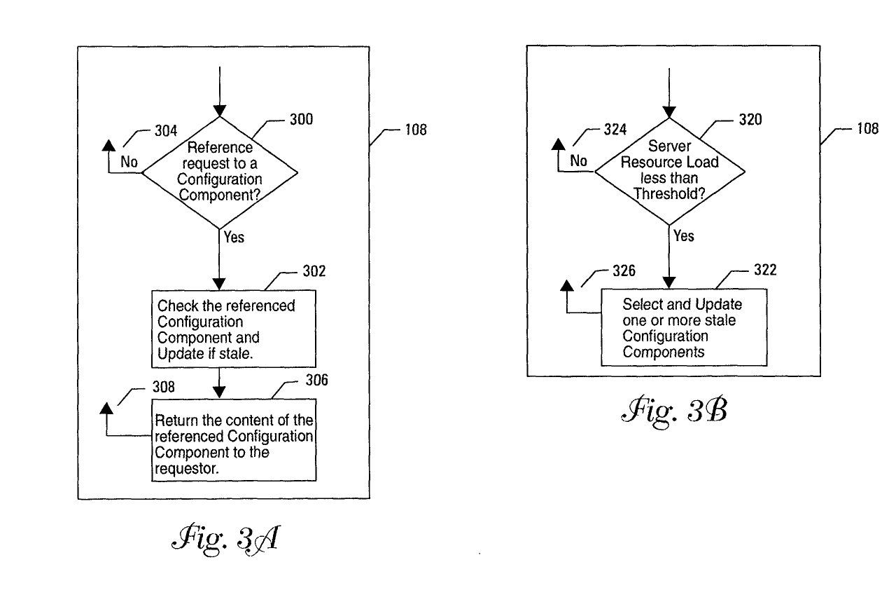

FIGS. 3A and 3B are flowchart diagrams of methods according to other embodiments of the present invention that update configuration components of the configuration server. The methods of FIGS. 3A and 3B relate to element 108 in FIG. 1.

FIG. 3A is a flowchart of one embodiment of a method of updating stale configuration components that utilizes an approach that each configuration component is checked in block 302 to see if it is stale only upon that configuration component being requested in block 300 and utilized by the configuration server. If no reference request 300 has occurred the process flow continues 304 to the main configuration update method described above with respect to FIG. 1 to check if a new configuration change event has occurred. If a reference request 300 has occurred and the configuration component is stale it is then updated in block 302 if necessary. The configuration reference request is responded to in block 306 and the method returns 308 to a main configuration update method such as that described above with respect to FIG. 1 to check if a new configuration change event has occurred. This approach is advantageous in its simplicity and low overall overhead on the configuration server.

FIG. 3B is a flowchart of a method of updating stale configuration components according to another embodiment of the present invention. The method of FIG. 3B utilizes an approach where one or more of the stale configuration components are updated when the resource usage or load of the configuration server falls below a specified threshold as determined in decision block 320 and the stale configuration components can be updated without adversely affecting the performance of a configuration server or the network or system it is a part of. In FIG. 3B, the configuration server resource load or usage is checked to see if it is less than a specified threshold in decision block 320. If the configuration server resource load or usage is above the threshold level the method returns 324 to a main configuration update method such as that described above with respect to FIG. 1 to check if a new configuration change event has occurred. If the configuration server resource load or usage is below the threshold level, one or more of the stale configuration components are selected and updated in block 322 before the method returns 326 to a main configuration update method such as that described above with respect to FIG. 1 to check if a new configuration change event has occurred. The configuration server resource usage or load can be any single or multiple load or resource measure that can have an affect on the performance of the system. Examples of such configuration server load or resource measures include, but are not limited to, processor load levels, memory usage levels, input/output (I/O) usage levels, network interface(s) usage level, network link usage levels, etc.

In another embodiment, the methods of FIGS. 3A and 3B are combined to provide an approach that allows for both the referenced configuration component updating of the method of FIG. 3A and the load/usage level dependent updating of configuration components of FIG. 3B.

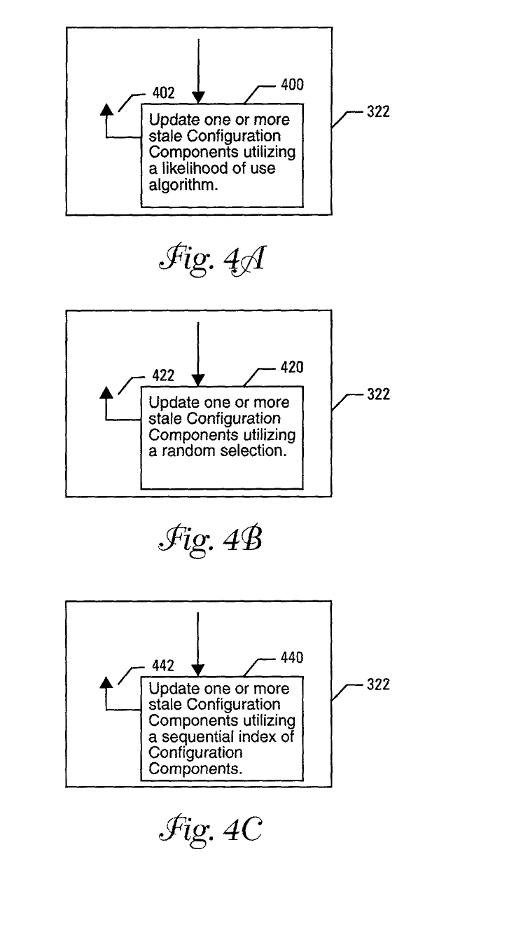

FIGS. 4A, 4B, and 4C are flowchart diagrams of methods according to still other embodiments of the present invention that select and update stale configuration components of the configuration server utilizing various algorithms. The methods of FIGS. 4A, 4B, and 4C relate to element 322 in FIG. 3B.

FIG. 4A is shown a flowchart of a method of updating stale configuration components according to another embodiment of the present invention that utilizes a likelihood of use algorithm. In FIG. 4A, one or more of the stale configuration components are selected and updated in block 400 according to an indication of the likelihood of the configuration component being used again in the future. The method then returns 402 to a main configuration update method such as that described above with respect to FIG. 1 to check if a new configuration change event has occurred. Examples of likelihood of use algorithms include, but are not limited to, most recently used, least recently used (allowing prioritization of a set of stale configuration components by eliminating the configuration components least likely to be referenced), prioritization by function (so that the configuration components with the most generic use are selected for update first), and prioritization by time and space locality (so that the configuration components that have been referenced most recently and thus are most likely to be referenced again and the configuration components that are related to them and therefore are also likely to be referenced are updated first).

FIG. 4B is a flowchart of a method of updating stale configuration components according to another embodiment of the present invention that utilizes a random selection and update algorithm. In FIG. 4B, one or more of the stale configuration components are selected and updated in block 420 according to a random selection criteria for the configuration component. The method then returns 422 to a main configuration update method such as that described above with respect to FIG. 1 to check if a new configuration change event has occurred.

FIG. 4C is a flowchart of a method of updating stale configuration components according to yet another embodiment of the present invention that utilizes a sequential selection and update algorithm for the stale configuration components. In FIG. 4C, one or more of the stale configuration components are selected and updated in block 440 according to a predetermined sequence and/or index selection criteria for the configuration component. The method then returns 442 to a main configuration update method such as that described above with respect to FIG. 1 to check if a new configuration change event has occurred.

It is noted that other stale configuration component selection and update algorithms will be apparent to those skilled in the art with the benefit of the present disclosure, and are within the scope of the present invention.

While the above description of configuration servers and their managed configuration components applies to conventional configuration servers and their design, other embodiments of the present invention include configuration servers based on an object oriented approach. In an object oriented configuration server the configuration components are embodied in instances of configuration component objects that are part of the configuration server's object model. Such configuration component objects can be built of one or more parent object classes, inheriting class functions and characteristics from the parent object classes. In such embodiments of the present invention it is the instances of the configuration component objects in the configuration server that are identified as stale when a configuration request is received. The object instances are then updated according to the configuration server's dynamic update algorithm in the manner described above.

Alternative manners of configuration server dynamic configuration component updating utilizing embodiments of the present invention will be apparent to those skilled in the art with the benefit of the present disclosure, and are also within the scope of the present invention.

### Conclusion

A configuration server apparatus and method are described that allows for improved dynamic updates of configuration components managed by the configuration server. Configuration servers allow for configuration and tasking of elements of a network or network system. In the improved configuration server, when a configuration change event is received underlying input files and information databases are updated to reflect the change. Each configuration component, which is utilized by the configuration server to generate an appropriate response for a configuration request, is identified as stale by timestamping or marking as stale. When a configuration request is received next, each configuration component that is utilized by the request is then dynamically checked and updated if stale by the configuration server from the underlying input files and information databases. Alternative embodiments of the improved configuration server apparatus and method identify only the configuration components affected by the configuration change event or update one or stale configuration components according to a specified selection algorithm when the configuration server resources drop below a specified threshold.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method of operating a configuration server with a plurality of configuration components, comprising:
receiving a configuration change event;
identifying each configuration component as stale; and
updating each configuration component as the configuration component is referenced by a request to the configuration server.

2. The method of claim 1, wherein identifying each configuration component as stale further comprises timestamping each configuration component.

3. The method of claim 2, wherein timestamping each configuration component further comprises timestamping selected configuration files or information databases.

4. A method of dynamically updating a plurality of configuration components, comprising:
receiving a configuration change event;
marking each configuration component of the plurality of configuration components as stale; and
updating each configuration component of the plurality of configuration components as the configuration component is accessed.

5. The method of claim 4, wherein marking each configuration component as stale further comprises timestamping each configuration component.

6. The method of claim 5, wherein timestamping each configuration component further comprises timestamping selected underlying files or information databases.

7. The method of claim 4, wherein receiving a configuration change event further comprises receiving a simple network management protocol (SNMP) change event.

8. A method of operating an object oriented configuration server with a plurality of configuration objects, comprising:
receiving a configuration change event;
marking all configuration objects as stale; and
updating each configuration object as the configuration object is referenced by a request to the configuration server.

9. The method of claim 8, wherein marking all configuration objects as stale further comprises timestamping configuration objects.

10. The method of claim 9, wherein timestamping configuration objects further comprises timestamping parent objects.

11. The method of claim 8, wherein receiving a configuration change event further comprises receiving an object generated internal change event.

12. The method of claim 8, wherein receiving a configuration change event further comprises receiving a simple network management protocol (SNMP) change event.

13. A method of operating an object oriented configuration server with a plurality of configuration objects, comprising:
receiving a configuration change event;
determining which configuration objects are affected by the configuration change event;
identifying each configuration object that is affected by the configuration change event as stale; and
updating each stale configuration object as the configuration object is referenced by a request to the configuration server.

14. The method of claim 13, wherein identifying each configuration object as stale further comprises timestamping each configuration object.

15. The method of claim 14, wherein timestamping each configuration object further comprises timestamping underlying files, parent objects, or information databases.

16. The method of claim 13, wherein receiving a configuration change event further comprises receiving an internally generated change event.

17. The method of claim 13, wherein receiving a configuration change event further comprises receiving a simple network management protocol (SNMP) change event.

18. A configuration server comprising:
a memory;
a network interface;
a processor coupled to the memory and the network interface; and
a computer-usable medium having computer readable instructions stored thereon for execution by a processor to perform a method comprising:
initializing a plurality of configuration components in the memory;
receiving a configuration change event;
marking all configuration components as stale; and
selectively updating each stale configuration component when the configuration server load is below a specified threshold.

19. The configuration server of claim 18, wherein configuration server load below a specified threshold further comprises one or more resource measures of the configuration server below a specified threshold.

20. The configuration server of claim 18, wherein the configuration components further comprise object instances of objects in a configuration server object model.

21. A computer-usable medium having computer readable instructions stored thereon for execution by a processor to perform a method comprising:
initializing a plurality of configuration components;
receiving a configuration change event;
marking each configuration component as stale; and
updating each configuration component as the configuration component is referenced by a request to the configuration server.

22. The computer-usable medium of claim 21, wherein marking each configuration component as stale further comprises timestamping each configuration component.

23. The computer-usable medium of claim 22, wherein timestamping each configuration component further comprises timestamping underlying files or information databases.

24. A method of operating a configuration server with a plurality of configuration components, comprising:
receiving a configuration change event;
identifying selected configuration components as stale; and
updating stale configuration components according to a selected algorithm.

25. The method of claim 24, wherein identifying selected configuration components as stale further comprises identifying each configuration component as stale.

26. The method of claim 24, wherein identifying selected configuration components as stale further comprises identifying the configuration components that are affected by the configuration change event as stale.

27. The method of claim 24, wherein updating stale configuration components according to a selected algorithm further comprises updating each configuration component as the configuration component is referenced by a request to the configuration server.

28. The method of claim 24, wherein updating stale configuration components according to a selected update algorithm further comprises selectively updating one or more configuration components when one or more resource measures of the configuration server are below a specified threshold.

29. The method of claim 28, wherein the resource measures are selected from the group consisting of processor load, memory usage, input/output (I/O) usage, network interface usage, and network link usage.

30. The method of claim 28, wherein the update algorithm is selected from the group consisting of a likelihood of use algorithm, a random selection and update algorithm, and a sequential selection and update algorithm.

31. The method of claim 30, wherein the likelihood of use algorithm is selected from the group consisting of most recently used, least recently used, prioritization by function, and prioritization by time and space locality.

32. The method of claim 24, wherein identifying selected configuration components as stale further comprises timestamping configuration components.

33. The method of claim 32, wherein timestamping configuration components further comprises timestamping underlying files or information databases.

34. The method of claim 24, wherein receiving a configuration change event further comprises receiving an internally generated change event.

35. The method of claim 24, wherein receiving a configuration change event further comprises receiving a simple network management protocol (SNMP) change event.

36. A method of dynamically updating a plurality of configuration components, comprising:
receiving a configuration change event;
identifying selected configuration components of the plurality of configuration components as stale; and
updating stale configuration components of the plurality of configuration components according to a selected update algorithm.

37. The method of claim 36, wherein identifying selected configuration components as stale further comprises identifying each configuration component as stale.

38. The method of claim 36, wherein identifying selected configuration components as stale further comprises identifying the configuration components that are affected by the configuration change event as stale.

39. The method of claim 36, wherein updating stale configuration components according to a selected algorithm further comprises updating each configuration component as the configuration component is referenced.

40. The method of claim 36, wherein updating stale configuration components according to a selected update algorithm further comprises selectively updating one or more configuration components when one or more resource measures are below a specified threshold.

41. The method of claim 40, wherein the resource measures are selected from the group consisting of processor load, memory usage, input/output (I/O) usage, network interface usage, and network link usage.

42. The method of claim 40, wherein the update algorithm is selected from the group consisting of a likelihood of use algorithm, a random selection and update algorithm, and a sequential selection and update algorithm.

43. The method of claim 42, wherein the likelihood of use algorithm is selected from the group consisting of most recently used, least recently used, prioritization by function, and prioritization by time and space locality.

44. The method of claim 36, wherein identifying selected configuration components as stale further comprises timestamping configuration components.

45. The method of claim 44, wherein timestamping configuration components further comprises timestamping underlying files or information databases.

46. The method of claim 36, wherein receiving a configuration change event further comprises receiving an internally generated change event.

47. The method of claim 36, wherein receiving a configuration change event further comprises receiving a simple network management protocol (SNMP) change event.

48. A method of operating an object oriented configuration server with a plurality of configuration object instances, comprising:
receiving a configuration change event;
marking selected configuration object instances as stale; and
updating each configuration object instance according to a selected update algorithm.

49. The method of claim 48, wherein identifying selected configuration object instances as stale further comprises identifying each configuration object instance as stale.

50. The method of claim 48, wherein identifying selected configuration object instances as stale further comprises identifying the configuration object instances that are affected by the configuration change event as stale.

51. The method of claim 48, wherein updating stale configuration object instances according to a selected algorithm further comprises updating each configuration object instance as the configuration object instance is referenced by a request to the configuration server.

52. The method of claim 48, wherein updating stale configuration object instances according to a selected update algorithm further comprises selectively updating one or more configuration object instances when one or more resource measures of the configuration server are below a specified threshold.

53. The method of claim 52, wherein the resource measures are selected from the group consisting of processor load, memory usage, input/output (I/O) usage, network interface usage, and network link usage.

54. The method of claim 52, wherein the update algorithm is selected from the group consisting of a likelihood of use algorithm, a random selection and update algorithm, and a sequential selection and update algorithm.

55. The method of claim 54, wherein the likelihood of use algorithm is selected from the group consisting of most recently used, least recently used, prioritization by function, and prioritization by time and space locality.

56. The method of claim 48, wherein identifying selected configuration object instances as stale further comprises timestamping configuration object instances.

57. The method of claim 56, wherein timestamping configuration object instances further comprises timestamping underlying files, information databases, or configuration objects.

58. The method of claim 48, wherein receiving a configuration change event further comprises receiving an internally generated change event.

59. The method of claim 48, wherein receiving a configuration change event further comprises receiving a simple network management protocol (SNMP) change event.

60. A configuration server comprising:
a memory;
a network interface;
a processor coupled to the memory and the network interface; and
a computer-usable medium having computer readable instructions stored thereon for execution by a processor to perform a method comprising:
initializing a plurality of configuration components in the memory;
receiving a configuration change event;
identifying selected configuration components as stale; and
updating configuration components according to a selected update algorithm.

61. The configuration server of claim 60, wherein identifying selected configuration components as stale further comprises identifying each configuration component as stale.

62. The configuration server of claim 60, wherein identifying selected configuration components as stale further comprises identifying the configuration components that are affected by the configuration change event as stale.

63. The configuration server of claim 60, wherein the configuration components further comprise objects in a configuration server object model.

64. The configuration server of claim 60, wherein the configuration server is a provisioning server for a network.

65. The configuration server of claim 60, wherein the configuration server is a configuration server for a network rack system.

66. A computer-usable medium having computer readable instructions stored thereon for execution by a processor to perform a method comprising:
initializing a plurality of configuration components;
receiving a configuration change event;
identifying selected configuration components as stale; and
updating configuration components according to a selected update algorithm.

67. The computer-usable medium of claim 66, wherein identifying selected configuration components as stale further comprises identifying each configuration component as stale.

68. The computer-usable medium of claim 66, wherein identifying selected configuration components as stale further comprises identifying the configuration components that are affected by the configuration change event as stale.

69. The computer-usable medium of claim 66, wherein updating stale configuration components according to a selected algorithm further comprises updating each configuration component as the configuration component is referenced by a request to the configuration server.

70. The computer-usable medium of claim 66, wherein updating stale configuration components according to a selected update algorithm further comprises selectively updating one or more configuration components when one or more resource measures of the configuration server are below a specified threshold.

71. The computer-usable medium of claim 70, wherein the resource measures are selected from the group consisting of processor load, memory usage, input/output (I/O) usage, network interface usage, and network link usage.

72. The computer-usable medium of claim 70, wherein the update algorithm is selected from the group consisting of a likelihood of use algorithm, a random selection and update algorithm, and a sequential selection and update algorithm.

73. The computer-usable medium of claim 72, wherein the likelihood of use algorithm is selected from the group consisting of most recently used, least recently used, prioritization by function, and prioritization by time and space locality.

74. The computer-usable medium of claim 66, wherein identifying selected configuration components as stale further comprises timestamping configuration components.

75. The computer-usable medium of claim 74, wherein timestamping configuration components further comprises timestamping underlying files or information databases.

76. The computer-usable medium of claim 66, wherein receiving a configuration change event further comprises receiving an internally generated change event.

77. The computer-usable medium of claim 66, wherein receiving a configuration change event further comprises receiving a simple network management protocol (SNMP) change event.
